(19) United States
(12) Patent Application Publication
(10) Pub. No.: US 2008/0299890 A1
(43) Pub. Date: Dec. 4, 2008

(54) APPARATUS AND METHOD FOR VENTILATING AND COOLING ENCLOSURES DURING AN ELECTRICAL POWER FAILURE

(76) Inventors: Phillip S. Orrell, Easton, MD (US); John F. Williams, III, Cordova, MD (US)

Correspondence Address: MUSKIN & CUSICK LLC, 30 Vine Street, SUITE 6, Lansdale, PA, 19446, US

(21) Appl. No.: 11/755,621

(22) Filed: May 30, 2007

(51) Int. Cl. F24F 7/06; A01K 1/00

(52) U.S. Cl. 454/229; 119/448

(57) ABSTRACT

An auxiliary cooling system is provided, which can be driven by hydraulic power and can be capable of actuating ventilation fans, normally operated by electrical power, when electrical power becomes unavailable, or when electric motors become inoperable. This system can be used as part of a method, wherein voltage can be detected by detectors and transmitted to a monitoring unit. The monitoring unit can make automatic decisions, based on the received detections, concerning whether to turn on or off backup electrical generators, and whether to turn on or off the hydraulic auxiliary cooling system.

### FIELD OF THE INVENTION

An apparatus and method relating to auxiliary ventilation and cooling systems for use with buildings, including those that house livestock. More specifically, the present inventive concept is directed towards a hydraulic system which can be used to power cooling fans, normally actuated by electric motors when those electric motors have been rendered inoperable either by power surges or power outages.

### BACKGROUND

Modern poultry farming often utilizes large buildings, which can contain thousands of birds in close confinement. Such facilities require sufficient ventilation to supply the fresh-air needs of so many animals confined to a relatively small area. Additionally, the body heat created by so many birds, in addition to heat caused by the sun, can cause these buildings to warm to an extent that can become harmful or even fatal for the birds housed within them. In the absence of sufficient ventilation and cooling, animals will often begin dying within only ten to fifteen minutes.

In order to provide proper ventilation, such buildings are often cooled and ventilated by very large fans driven by electric motors. These fans are typically powered by electricity provided by an electrical power grid. However, many of these poultry facilities are also equipped with one or more backup electrical generators for use as a secondary power source in the event of a general power failure. Such generators are usually powered by internal combustion engines, which are activated during a power disruption. Despite the existence and use of these secondary systems, there have been many instances wherein both sources of electrical power have failed leading to the deaths of thousands of animals and resulting in substantial financial losses by the operators of such facilities. These failures can be caused by a concurrent interruption of the generating capacity provided by the power grid and backup generators. However, these failures can also result due to a power surge, often caused by lightening, which can destroy the electrical circuit required to transmit and utilize electricity, including the destruction of the electric motors required to actuate the ventilation fans.

What is needed is an auxiliary system which can be used to drive said cooling fans despite the failure of the power grid, backup generator, electrical circuitry, including electric motors, or failures of any combination of these components.

### SUMMARY OF THE INVENTION

It is an aspect of the current apparatus to provide a back-up cooling system for buildings, which works independently of electricity and electrical driving mechanisms.

The above aspect can be obtained by an apparatus that includes: (a) a hydraulic motor connected to a drive belt, which is connected to a ventilation fan; (b) an electric motor connected to said drive belt; and (c) a control unit capable of activating said hydraulic motor when said electric motor is determined to be inoperable.

The above aspects can also be obtained by a method for using said backup cooling system apparatus during a power failure that includes: (a) providing an electrical and hydraulic motor adopted to turn a belt or chain to activate a fan; (b) activating the electric motor; (c) detecting a first voltage available to operate the electric motor; (d) determining if said first voltage is sufficient to operate the electric motor; and (e) activating the hydraulic motor if said first voltage is determined to be insufficient.

Further, the above aspects can be obtained by a method for cooling and ventilating a building when an electric motor used to drive a fan is inoperable, the method comprising: (a) providing an electrical and hydraulic motor adopted to turn a belt or chain to activate a fan; (b) activating the electric motor; (c) detecting the operability of the electric motor; (d) determining if said electric motor is operable; and (e) activating the hydraulic motor if said electric motor is determined to be inoperable.

These, together with other aspects and advantages, which will subsequently become apparent, and reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the current apparatus, as well as the structure and operation of various embodiments of the current apparatus, will become apparent and more readily appreciated from the following description of the preferred embodiments, taken in conjunction with the accompanying drawings of which:

FIG. 1 is a perspective view of a powering apparatus for a hydraulic auxiliary ventilation and cooling apparatus comprising an internal combustion engine, a hydraulic pump, a hydraulic fluid reservoir, and incoming and outgoing hydraulic lines, according to an embodiment;

FIG. 2 is a perspective view of a ventilation fan assembly, comprising a belt driven ventilation fan, an electric motor, a hydraulic motor further comprising a centrifugal clutch, and hydraulic lines and valves, according to an embodiment;

FIG. 3 is an exploded view drawing of a hydraulic motor assembly comprising a centrifugal clutch, according to an embodiment;

FIG. 4 is a perspective view of a mounting apparatus wherein an electric motor and a hydraulic motor are removably attached to a mounting bracket so that both are in communication with a drive belt (not pictured) used to power a ventilation fan (not pictured).

FIG. 5 is a diagrammatic representation of a typical livestock confinement site plan equipped with a hydraulic auxiliary ventilation and cooling apparatus indicating the location of the powering mechanism for a hydraulic auxiliary ventilation and cooling apparatus, ventilation fan assemblies, and inlet curtains, according to an embodiment;

FIG. 6 is a flowchart representing the logic followed by a method for using a hydraulically-driven auxiliary ventilation and cooling apparatus, including its activation during an electrical power failure, according to an embodiment; and

FIG. 7 is a flowchart representing the logic followed by a monitoring system to determine the operability of electrical motors comprising one or more typical ventilation fan assemblies, and activating a hydraulically-driven auxiliary ventilation and cooling apparatus when said electrical motor is determined to be inoperable.

### DETAILED DESCRIPTION OF THE PREFERRED EMBODIMENTS

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top”and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

The present general inventive concept relates to an auxiliary ventilation and cooling apparatus for use with buildings, including but not limited to those that house livestock, which is capable of providing emergency power to large ventilation fans when electrical power is unavailable. Generally, this apparatus and a method for its use can provide ventilation and cooling for animal confinement facilities, sufficient to reduce the occurrence of animal mortality until electrical power can be restored.

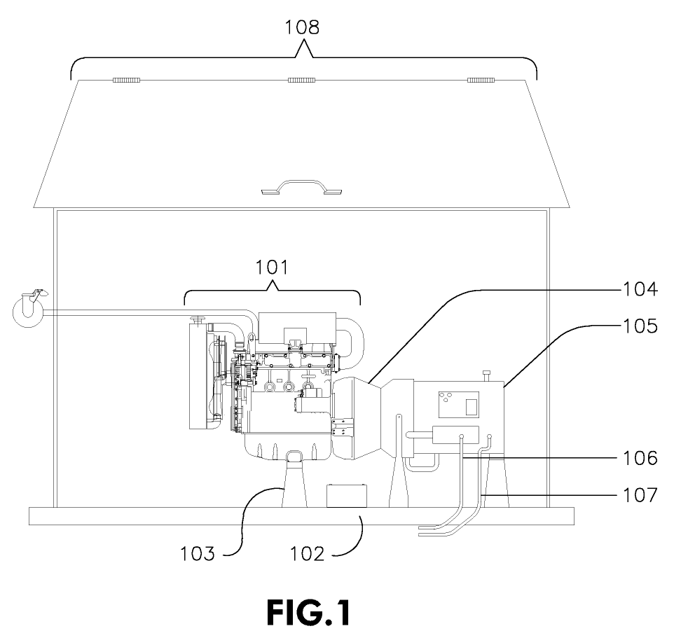

FIG. 1 is a perspective view of a powering apparatus for a hydraulic auxiliary ventilation and cooling apparatus comprising an internal combustion engine 101, a hydraulic pump 104, a hydraulic fluid reservoir 105, and a high-pressure, outgoing hydraulic line 106 and a return line 107, according to an embodiment;

A hydraulic system can function by using a pump to create pressurized flow of hydraulic fluid through hydraulic lines. The force of said pressurized hydraulic fluid can be transferred to the blades of a hydraulic motor by directing its flow through the blades of said hydraulic motor. In this way, torque can be created, which can be transferred to a radial fan assembly. For more information regarding hydraulically-driven systems see, for example, U.S. Pat. No. 4,516,467 which is incorporated herein by reference in its entirety

A hydraulic auxiliary ventilation and cooling apparatus can include an internal combustion engine 101, or similar power producing component. The internal combustion engine 101 can be a diesel engine, gasoline engine, gas/electric hybrid engine, or other suitable driving mechanism known to one of ordinary skill in the art. The internal combustion engine 101 can be securely mounted to a concrete slab 102 using standard motor mounts 103 and can be housed in a weather resistant housing 108.

A flywheel (not pictured) of an internal combustion engine 101 can be attached to a hydraulic pump 104 capable of pumping a sufficient volume of hydraulic fluid to power one or more hydraulic fluid motors (not pictured). Generally, each hydraulic motor can require two or more gallons of hydraulic fluid to flow through it per minute in order to provide adequate power to actuate a typical belt-driven ventilation fan (not pictured). The hydraulic fluid can be replaced with a suitable non-toxic fluid, such as peanut oil, which can prevent death or injury among animals exposed to the fluid due either to leak or similar event.

A hydraulic fluid reservoir 105 can be in communication with the hydraulic pump 104, and can be capable of containing a sufficient volume of hydraulic fluid to continuously supply the hydraulic pump 104 during its operation. Typically, this volume of hydraulic fluid should be no less than the amount required to power the total number of hydraulic motors (not pictured) in the hydraulic circuit for one minute. Therefore, if an auxiliary hydraulic cooling apparatus comprises ten hydraulic motors, each requiring two gallons per minute, the hydraulic fluid reservoir 105 should be capable of containing a minimum of 20 (or any other number) gallons of hydraulic fluid.

The hydraulic pump 104 can pump hydraulic fluid through a high-pressure line 106, commonly used for hydraulic systems, at a sufficient volume and pressure to actuate a hydraulic motor (not pictured). This high-pressure line can form a closed hydraulic circuit through which fluid can flow from the hydraulic pump 104 through a high-pressure, outgoing hydraulic line 106 to one or more hydraulic motors (not pictured) and then through a return line 107 back to the hydraulic fluid reservoir 105 to re-supply the hydraulic pump 104.

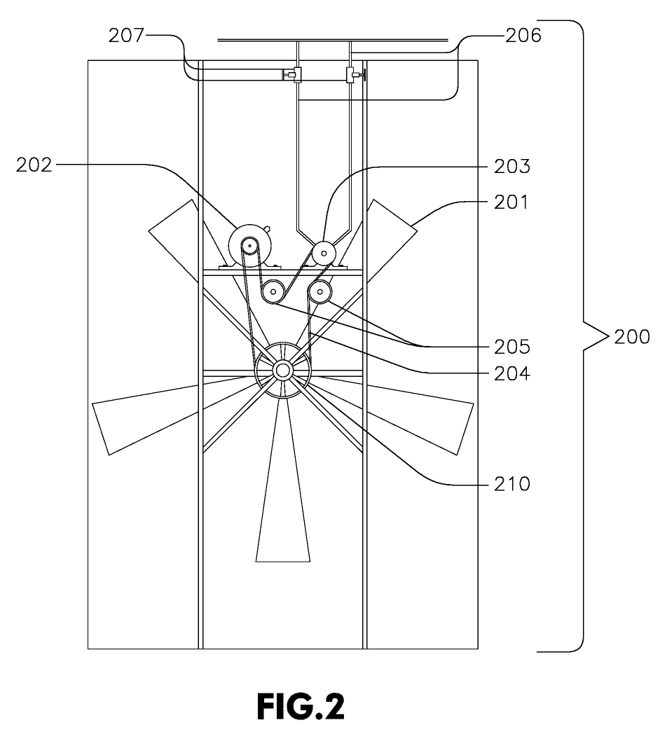

FIG. 2 is a perspective view of a ventilation fan assembly 200, comprising a belt-driven ventilation fan 201, an electric motor 202, a hydraulic motor 203, further comprising a centrifugal clutch (not pictured), and hydraulic lines 206 and valves 207, according to an embodiment.

An auxiliary ventilation and cooling system can comprise a belt-driven ventilation fan assembly 200 further comprising a multi-bladed radial fan 201. For more information regarding the components and operation of belt-driven ventilation fan assemblies, see, for example, U.S. Pat. No. 4,561,265 which is incorporated herein by reference in its entirety. Such ventilation fans 201 are typically actuated by an electric motor 202, which generate torque through a drive shaft (not pictured) comprising a pulley when subjected to an electrical load. This torque is transferred from the electric motor 202 to a fan pulley 210 by use of a drive belt 204, a chain (not pictured), or some other suitable force transferring device known to one in possession of ordinary skill in the art.

An auxiliary ventilation and cooling system can comprise a hydraulic motor 203, further comprising a centrifugal clutch (not pictured), which can be connected to the same drive belt 204 used by the electric motor 202 to drive the fan pulley 210. Belt tensioners and idlers 205 can be used to effectuate communication between pulleys driven by an electric motor 202, a hydraulic motor 203, and a fan pulley 210.

Hydraulic fluid can be delivered to the hydraulic motor 203 via high-pressure hoses or tubing 206, further comprising valves 207, which can be used to either actuate or bypass the hydraulic motor 203. The ability to bypass one or more ventilation fan assemblies, allows the hydraulic circuit to function and maintain pressure even if one or more of the hydraulic motors making up the hydraulic circuit, plugs, leaks, or otherwise malfunctions.

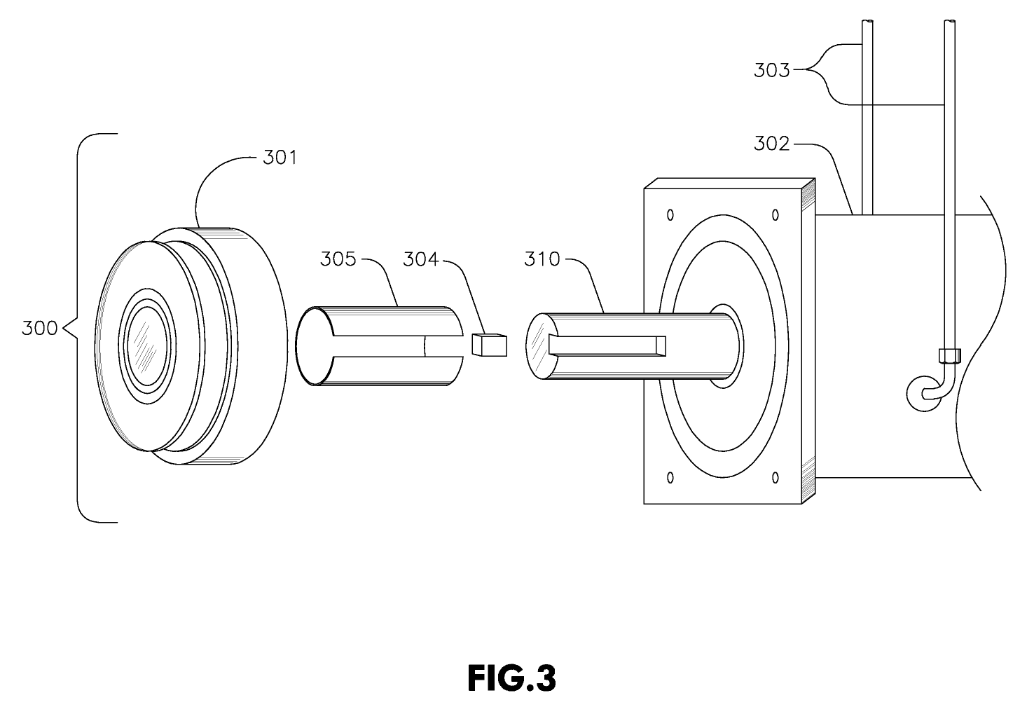

FIG. 3 is an exploded view drawing of a hydraulic motor assembly 300, further comprising a centrifugal clutch 301, according to an embodiment.

The hydraulic motor assembly 300 can comprise a hydraulic motor 302 capable of rotating a drive shaft 310 at 1800 revolutions per minute when subjected to hydraulic fluid (not pictured) at pressures equaling 1000 pounds per square inch via high-pressure fluid lines 303. The hydraulic motor assembly 300 can further comprise a centrifugal clutch 301, which can be adjusted to engage when the drive shaft spins at 1500 revolutions per minute. The drive shaft 310 would therefore spin freely when the hydraulic motor 302 rotates at less than 1500 revolutions per minute. This feature allows the internal combustion engine (not pictured) to reach its optimum torque levels before being subjected to the load from one or more hydraulic motors (302). Furthermore, the centrifugal clutch 301 can be adjusted to spin freely when the hydraulic motor 302 is not being used to actuate the ventilation fan (not pictured), which would typically be the case when electrical power is available. The centrifugal clutch 301 can be removably attached to the drive shaft 310 using a Woodruff Key 304 and a metal sleeve 305. For more information regarding centrifugal clutches, see, for example, U.S. Pat. No. 3,996,811 which is incorporated herein by reference in its entirety.

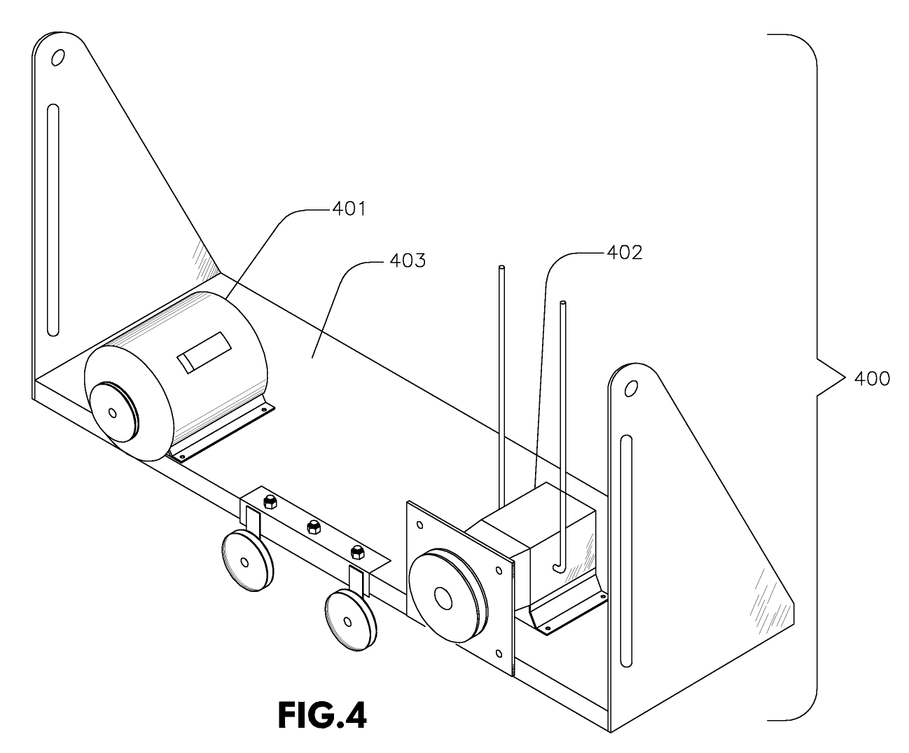

FIG. 4 is a perspective view of a mounting apparatus 400 wherein an electric motor 401 and a hydraulic motor 402 are removably attached to a mounting bracket 403 so that both are in communication with a drive belt (not pictured) used to power a ventilation fan (not pictured).

The mounting apparatus 400 allows two independent drive systems, one electric 401 and one hydraulic 402 to be mounted to a ventilation fan apparatus (not pictured) so that either drive system can be used to power the ventilation fan (not pictured) without attaching, removing, or reconfiguring any belts or other drive mechanisms when switching from electrical drive to hydraulic drive or vice versa.

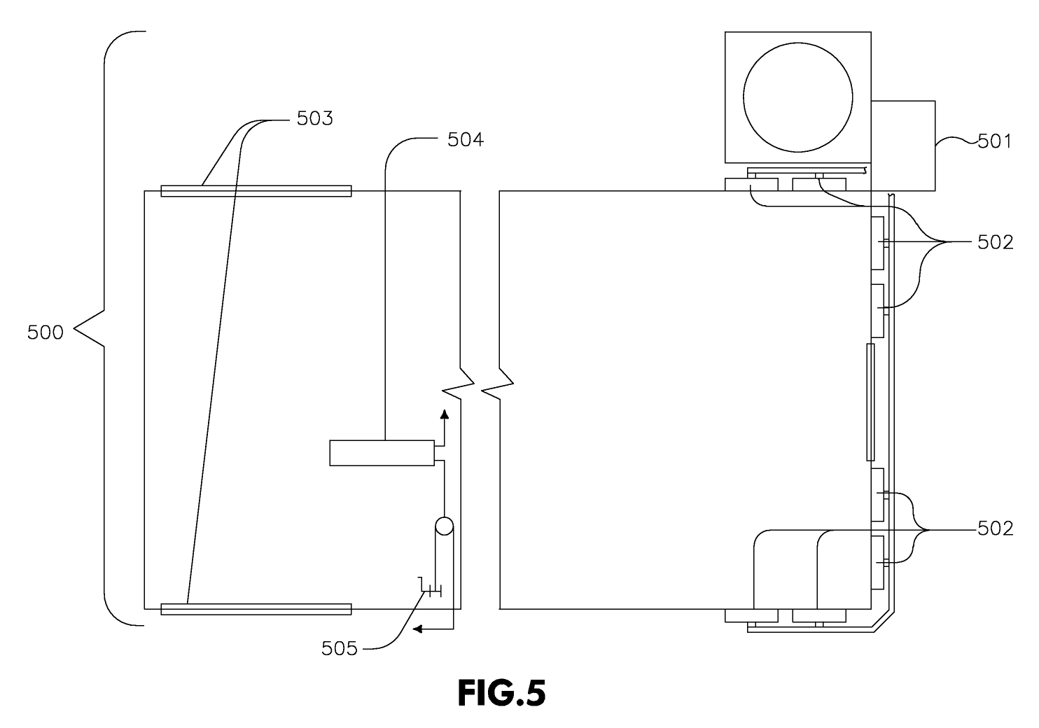

FIG. 5 is a diagrammatic representation of a typical livestock confinement site plan 500 equipped with a hydraulic auxiliary ventilation and cooling apparatus indicating the location of the powering mechanism for a hydraulic auxiliary ventilation and cooling apparatus 501, ventilation fan assemblies 502, and inlet curtains 503, further comprising automatic 504 and manual 505 mechanisms for activating the inlet curtains 503, according to an embodiment.

One end of a livestock confinement structure 500 equipped with a hydraulic auxiliary ventilation and cooling apparatus can comprise a series of ventilation fan assemblies 502, such as the one described in FIG. 2. These ventilation fan assemblies 502 can each move air from inside the structure 500 to the outside. Fresh air can enter through the openings created by the inlet curtains 503 or tunnel doors (not pictured) on a first end of the building and can be exhausted by the ventilation fans 502 on a second end of the building creating airflow throughout the length of the structure 500.

Under typical operating conditions, when electrical power is available, inlet curtains 503 or tunnel doors can be opened or closed using a controller 504, which will move the inlet curtains 503 up or down to increase or decrease air flow. Controllers 504 can typically contain a feature wherein the inlet curtains 503 can be automatically moved down in the event of a power failure maximizing airflow. For more information regarding inlet curtain systems, see, for example, U.S. Pat. No. 5,119,762 which is incorporated herein by reference in its entirety. These systems can be equipped with a manual crank 505, which can be used to adjust the inlet curtains 503 in the event of a controller 504 failure.

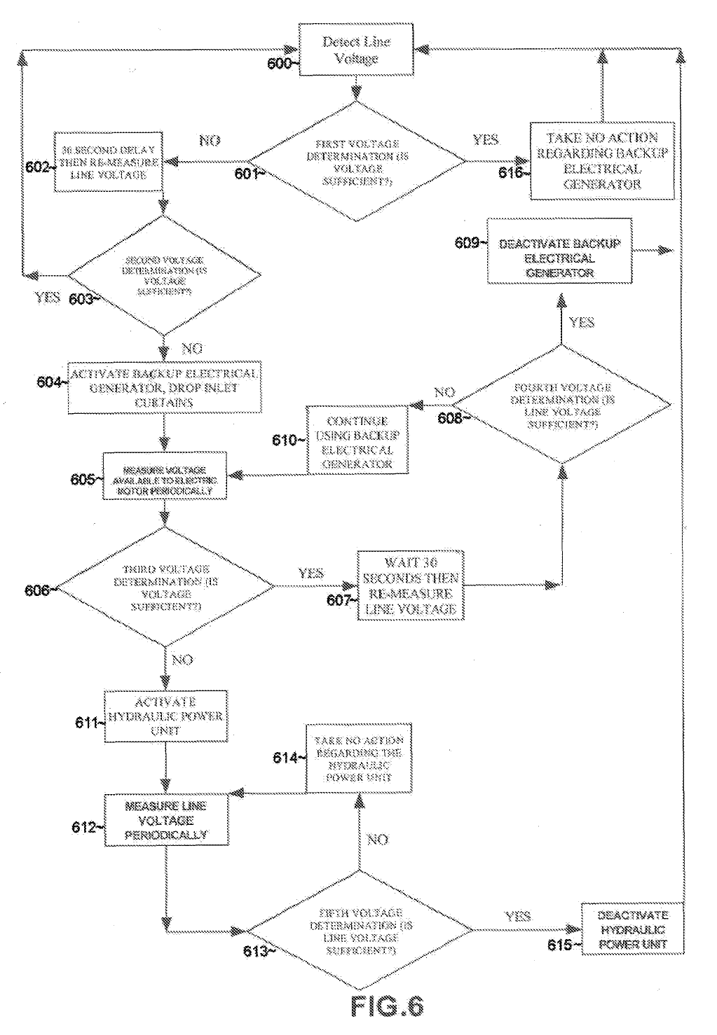

FIG. 6 is a flowchart representing the logic followed by a method for using a hydraulically-driven auxiliary ventilation and cooling apparatus, including its activation during an electrical power failure, according to an embodiment.

The method can begin with a first voltage detection in operation 600, wherein the electricity (voltage level) available to operate a building's ventilation fans can be detected. For more information regarding how to detect line voltage, see for example U.S. Pat. No. 3,987,393 which is incorporated by reference in its entirety. The sufficiency of the voltage detected in operation 600 is determined in a first voltage determination in operation 601. If the voltage is detected 600 and determined to be sufficient 601(for example, greater than 200 volts), this indicates typical electrical input from a utility grid, meaning no auxiliary power is required (so no action is taken 616) and the method can return to operation 600. If the voltage is detected in operation 600 and determined to be insufficient (for example less than 180 volts) in operation 601, this can indicate that a power failure has occurred, which may require the activation of an auxiliary electrical generator 604. However, in order to avoid unnecessary activations of the auxiliary electrical generator due to brief power interruptions or fluxuations, operation 602 can contain a thirty (30) second delay, after which a second voltage detection can be made. The second voltage detection 602 can be made followed by a second voltage determination 603. If sufficient voltage is determined to exist in operation 603 indicating typical electrical input from a utility grid, no auxiliary power is required to operate the ventilation fans and the method can return to operation 600. If an insufficient voltage is determined to exist in operation 603, the method can proceed to operation 604 wherein an auxiliary electrical generator can be activated, and one or more inlet curtains can be allowed to open completely. After a short pause (for example, 6 seconds), the method can proceed to operation 605 wherein the voltage available to the ventilation and cooling system's electrical circuitry can be measured. The operability of the auxiliary electrical generator can be determined after a third voltage detection in operation 605 and a third voltage determination in operation 606. If a sufficient voltage is determined to be available to the ventilation and cooling system in operation 606, this indicates that the auxiliary electrical generator is operable. The method then proceeds to operation 607 wherein a fourth voltage detection is measured and a fourth voltage determination 608 is made. This fourth voltage detection 607 and determination 608 measures line voltage available from the utility grid. If sufficient line voltage is detected in operation 607 and determined in operation 608, this indicates that sufficient electrical input from a utility grid is once again available. Therefore, no auxiliary power is required to operate the ventilation fans and the backup electrical generator can be deactivated in operation 609 and the method can return to operation 600. If insufficient line voltage is detected in operation 607 and determined in operation 608, the backup electrical generator remains activated 610 and the method returns to operation 605 wherein the voltage available to the ventilation and cooling system is periodically detected. If an insufficient voltage is detected in operation 605 and determined in operation 606, this indicates that the auxiliary electrical generator has also failed, and a hydraulic auxiliary ventilation and cooling apparatus can be activated in operation 611. After the hydraulic auxiliary ventilation and cooling apparatus has been activated in operation 611, a fifth voltage detection can be made periodically 612 (for example, every 5 seconds) and a fifth voltage determination can be made in operation 613. This fifth voltage detection 612 and determination 613 establishes whether sufficient line voltage is available from the utility grid. If insufficient line voltage is detected, the hydraulic auxiliary ventilation and cooling apparatus can remain activated 614 and the method can return to operation 612 wherein line voltage is periodically detected. If the amount of line voltage detected in operation 612 and determined in operation 613 is sufficient, the hydraulic auxiliary ventilation and cooling apparatus can be deactivated 615 and the method can return to operation 600.

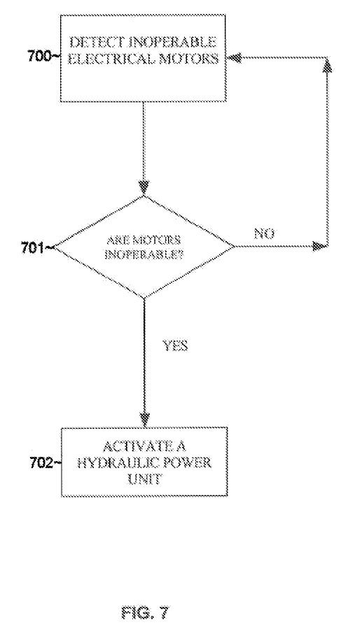

FIG. 7 is a flowchart representing the logic followed by a monitoring system which can be used to determine the operability of electrical motors comprising one or more typical ventilation fan assemblies, and activating a hydraulically-driven auxiliary ventilation and cooling apparatus when said electrical motor is determined to be inoperable.

The method can begin with operation 700, wherein the operability of one or more electrical motors typically used to drive large ventilation fans is detected. This detection can be made by measuring the current that passes through the circuit used to power the electrical motors. An inoperable motor can be detected if sufficient voltage is available in the circuit, but no current is flowing through the circuit. In operation 701 the operability of one or more electrical motors can be determined. If the electrical motor(s) are determined to be operable, the method returns to operation 700. If the electrical motor(s) are determined to be inoperable, the method can proceed to operation 702 wherein a hydraulic auxiliary ventilation and cooling apparatus can be activated.

The hydraulic auxiliary ventilation and cooling system can be activated and deactivated manually, wherein the methods described above can be overridden if necessary.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A hydraulically-driven auxiliary ventilation and cooling apparatus for an enclosure, the apparatus comprising:
a hydraulic motor connected to a drive belt or drive chain, the hydraulic motor connected to a ventilation fan;
an electric motor connected to said drive belt or drive chain; and
a control unit to activate said hydraulic motor when said electric motor is determined to be inoperable.

2. The apparatus as recited in claim 1, wherein said electric motor is determined to be inoperable when a monitoring unit detects insufficient voltage to power the electric motor.

3. The apparatus as recited in claim 1, wherein after the control unit activates the hydraulic motor, the control unit deactivates the hydraulic motor when said electric motor is determined to be operable.

4. The apparatus as recited in claim 3, wherein said electric motor is determined to be operable when a monitoring unit detects sufficient voltage to power the electric motor.

5. The apparatus as recited in claim 1, further comprising a monitoring unit.

6. The hydraulically-driven auxiliary ventilation and cooling apparatus as recited in claim 1 wherein the enclosure is a building where livestock is housed.

7. The hydraulically-driven auxiliary ventilation and cooling apparatus as recited in claim 1 wherein hydraulic fluid used to actuate the hydraulic motor is non-toxic.

8. The hydraulically-driven auxiliary ventilation and cooling apparatus as recited in claim 1 wherein the hydraulic motor further comprises a centrifugal clutch.

9. The hydraulically-driven auxiliary ventilation and cooling apparatus as recited in claim 2 wherein the hydraulic motor further comprises a centrifugal clutch.

10. The hydraulically-driven auxiliary ventilation and cooling apparatus as recited in claim 3 wherein the hydraulic motor further comprises a centrifugal clutch.

11. The hydraulically-driven auxiliary ventilation and cooling apparatus as recited in claim 4 wherein the hydraulic motor further comprises a centrifugal clutch.

12. The hydraulically-driven auxiliary ventilation and cooling apparatus as recited in claim 5 wherein the hydraulic motor further comprises a centrifugal clutch.

13. The hydraulically-driven auxiliary ventilation and cooling apparatus as recited in claim 6 wherein the hydraulic motor further comprises a centrifugal clutch.

14. A method for cooling and ventilating a building, the method comprising:
providing an electrical and a hydraulic motor adapted to turn a belt or chain to activate a fan;
activating the electric motor;
determining if said electric motor is operable; and
activating the hydraulic motor if said electric motor is determined in the determining to be inoperable.

15. The method for cooling and ventilating a building when as recited in claim 14 wherein the hydraulic motor is activated by a control unit.

16. The method for cooling and ventilating a building as recited in claim 14 wherein the determining is performed by a monitoring unit.

17. The method for cooling and ventilating a building as recited in claim 14, wherein said electric motor is determined to be inoperable when a detected voltage used to operate said electric motor is determined to be insufficient.

18. The method for cooling and ventilating a building when as recited in claim 17 wherein the hydraulic motor is activated by a control unit.

19. The method for cooling and ventilating a building as recited in claim 17 wherein the determining is performed by a monitoring unit.

20. A hydraulically-driven auxiliary ventilation and cooling apparatus for an enclosure, the apparatus comprising:
a hydraulic motor, further comprising a centrifugal clutch, connected to a drive belt or drive chain, the hydraulic motor connected to a ventilation fan;
an electric motor connected to said drive belt or drive chain; and
a control unit to activate said hydraulic motor when said electric motor is determined to be inoperable.
